(19) United States
(12) Patent Application Publication
(10) Pub. No.: US 2026/0222022 A1
(43) Pub. Date: Jul. 30, 2026

(54) METHOD AND APPARATUS FOR ACQUIRING LINEAR PRECODER ON BASIS OF MACHINE LEARNING IN MULTI-USER MIMO WIRELESS COMMUNICATION SYSTEM

(71) Applicant: KOREA UNIVERSITY RESEARCH AND BUSINESS FOUNDATION, Seoul (KR)

(72) Inventors: In Kyu LEE, Seoul (KR); Jeong Hyeon JANG, Seoul (KR)

(21) Appl. No.: 18/722,394

(22) PCT Filed: Aug. 31, 2022
(86) PCT No.: PCT/KR2022/013054

§ 371 Date: Jun. 20, 2024

(30) Foreign Application Priority Data
Dec. 20, 2021 (KR) 10-2021-0182697

(51) Int. Cl. H04B 7/0456

(52) U.S. Cl. CPC H04B 7/0456

(57) ABSTRACT

The present disclosure relates to a method by which a transmission end transmits a signal on the basis of a precoder in a multi-user MIMO wireless communication system, according to one embodiment of the present disclosure, comprises the steps of: acquiring a precoder by inputting channel information received from each of K (K is an integer greater than 0) reception ends into a trained precoder operation module; and transmitting a precoded signal to each of the K reception ends on the basis of the acquired precoder, wherein the precoder operation module can comprise a deep neural network to which a weight matrix W, a reception filter matrix U, and a normalization constant β are applied.

### TECHNICAL FIELD

The present disclosure relates to a precoder in a wireless communication system, and particularly, relates to a method and a device for obtaining a linear precoder based on machine learning in a multi-user MIMO wireless communication system.

### BACKGROUND ART

In a multi-user multiple input multiple output (MIMO) (MU-MIMO) wireless communication system, when data is transmitted or received by using a downlink channel, one base station may transmit information to multiple users/terminals simultaneously. To this end, after a base station acquires channel information between each terminal and base station (e.g., receives feedback on channel information from each terminal), precoding may be applied before a base station transmits data. Precoding (or beamforming) refers to mapping a transmission stream that a transmission end wants to transmit to multiple antennas (or antenna ports), and that mapping relationship may be expressed by a precoding matrix/vector (or a beamforming matrix/vector).

Unlike a single-user system that considers only a channel between one terminal and one base station, in a multi-user system, a channel between each terminal and base station as well as interference between terminals must be additionally considered. For example, a base station with Nt antennas may transmit pilot signal P to each of K terminals (one terminal has Nr antennas), each terminal may give a base station feedback on an estimated channel state information (CSI) based on P and a base station may determine a precoder that minimizes system performance (e.g., maximizing the overall transmission rate) and interference between terminals. In this regard, dirty paper coding (DPC) and nonlinear precoding techniques are known to have high frequency efficiency, but they are difficult in terms of actual implementation, so a linear precoding technique which is relatively easy to implement is widely used. A medium in charge of this precoding is called a linear precoder, and a precoder using a weighted minimum squared error (WMMSE) algorithm is known to have optimal performance.

In a MU-MIMO system, there is a problem that an WMMSE algorithm-based precoder requires a repetitive operation to obtain optimal performance, and high-complexity calculation is required for each repetition. Application of maching learning such as deep learning may be considered to reduce the complexity of a repetitive operation, but a deep learning-based precoder design and transmission or reception technique has a limitation in performance improvement because it mainly implements both input and output with one deep neural network (DNN). Accordingly, a new method for applying a deep learning technique to an WMMSE algorithm is required.

### DISCLOSURE

### Technical Problem

A technical problem of the present disclosure provides a new precoding method and device that combine and supplement a deep learning technique and an WWMSE method requiring repetitive performance for a linear precoder used in a MU-MIMO wireless communication system.

A technical problem of the present disclosure provides a method and a device that compress a repetitive operation into one mapping function through DNN training by considering that each repetition of an WMMSE method is optimized with a specific objective function for a linear precoder used in a MU-MIMO wireless communication system.

An additional technical problem of the present disclosure provides a precoding method and device that has lower complexity than an WMMSE technique and higher performance than a deep learning technique composed only of DNNs for a linear precoder used in a MU-MIMO wireless communication system.

Technical problems that the present disclosure attempted to solve are not limited to the technical problems described above. From the legend “DETAILED DESCRIPTION OF THE INVENTION”, it would be apparent to a person of ordinary skill in the art that there are other technical problems that are not mentioned.

### Technical Solution

A method, by which a transmission end transmits a signal based on a precoder in a multi-user multiple input multiple output (MIMO) wireless communication system, according to an aspect of the present disclosure may include acquiring a precoder by inputting channel information received from each of K (K is an integer greater than 0) reception ends into a trained precoder operation module; and transmitting a precoded signal to each of the K reception ends based on the acquired precoder, wherein the precoder operation module may include a deep neural network to which weight matrix W, reception filter matrix U and normalization constant β are applied.

A transmission device for transmitting a signal based on a precoder in a multi-user multiple input multiple output (MIMO) wireless communication system according to an additional aspect of the present disclosure may include a transceiver; an antenna unit; a memory; and a processor. The processor may be configured to acquire a precoder by inputting channel information received from each of K (K is an integer greater than 0) reception ends into a trained precoder operation module; and transmit a precoded signal to each of the K reception ends based on the acquired precoder through the transceiver. The precoder operation module may include a deep neural network to which weight matrix W, reception filter matrix U and normalization constant β are applied.

Features of the present invention, which are summarized above, are only exemplary aspects of the present disclosure and do not impose any limitation on the scope of the present disclosure.

### Advantageous Effects

According to the present disclosure, a new precoding method and device that combine and supplement a deep learning technique and an WWMSE method requiring repetitive performance for a linear precoder used in a MU-MIMO wireless communication system may be provided.

According to the present disclosure, a method and a device that compress a repetitive operation into one mapping function through DNN training by considering that each repetition of an WMMSE method is optimized with a specific objective function for a linear precoder used in a MU-MIMO wireless communication system may be provided.

According to the present disclosure, a precoding method and device that has lower complexity than an WMMSE technique and higher performance than a deep learning technique composed only of DNNs for a linear precoder used in a MU-MIMO wireless communication system may be provided.

Advantages that are to be achieved according to the present disclosure are not limited to those described above. From the legend “DETAILED DESCRIPTION OF THE INVENTION”, it would be apparent to a person of ordinary skill in the art that there are advantages that are not mentioned.

### DESCRIPTION OF DRAWINGS

FIG. 1 is a diagram showing a structure of a wireless communication system to which the present disclosure may be applied.

FIG. 2 is a diagram for describing a structure of a fully-connected deep neural network to which the present disclosure may be applied.

FIG. 3 is a diagram for describing a machine learning-based linear precoder design according to an embodiment of the present disclosure.

FIG. 4 is a diagram for describing a precoded signal transmission method according to the present disclosure.

FIG. 5 is a diagram showing a configuration of a transmission device according to the present disclosure.

FIG. 6 is a diagram showing a simulation result according to examples of the present disclosure.

### BEST MODE

Embodiments of the present disclosure will be described in detail below with reference to the accompanying drawings in such a manner that a person of ordinary skill in the art to which the present disclosure pertains is enabled to practice them without undue experimentation. However, the present disclosure can be implemented by modification, substitution, improvement, and the like and is not limited to the embodiments that will be described below.

When describing the embodiments of the present disclosure, in a case where detailed descriptions of configurations or functions known in the related art are determined to make the nature and gist of the present disclosure indefinite, the detailed descriptions thereof are omitted. Elements that do not relate to the description of the present disclosure are omitted from the drawings, and like elements are given like reference characters.

In the present disclosure, when a constituent element is referred to as being “connected to”, being “combined with”, and having “access to” one other constituent element, this means that the constituent element may be directly connected to one other constituent element or may be “indirectly connected to one other constituent with an intervening constituent element in between. When the expression “include a constituent element” or “have a constituent element” is used, unless otherwise described, this expression means “further include at least one other constituent element, not “exclude any other constituent element”.

In the present disclosure, the terms “first”, “second”, and so on are used to distinguish one constituent element from another constituent element, and unless otherwise described, no limitation is imposed on the order of constituent elements or the importance of each constituent element. Therefore, a first constituent element according to an embodiment within the scope of the present disclosure may be referred to as a second constituent element according to another embodiment. Similarly, a second constituent element according to an embodiment may be referred to as a first constituent element according to another embodiment.

In the present disclosure, the use of the terms “first”,

“second”, and so on serves to definitely describe features of each of the distinguishable constituent elements and does not mean that constituent elements are necessarily separated from each other. That is, multiple constituent elements may be integrated into one piece of hardware or one piece of software, and one constituent element may be separated into multiple pieces of hardware or multiple pieces of software. Therefore, although not specifically mentioned, an embodiment resulting from the integration or an embodiment resulting from the separation falls within the scope of the present disclosure.

In the present disclosure, constituent elements according to various embodiments are not necessarily intended to be essential constituent elements, and one or several thereof may be selected. Therefore, another embodiment including constituent elements, selected from among constituent elements that are described below and which constitute an embodiment, also falls within the scope of the present disclosure. In addition, an embodiment, which results from adding one or more constituent elements to constituent elements that constitute various embodiments described below, also falls within the scope of the present disclosure.

The present disclosure relates to communication between network nodes in a wireless communication system. Network nodes include at least one of the following: a base station, a terminal, or a relay. The term base station (BS) is used interchangeably with the terms fixed station, Node B, eNodeB (eNB), ng-eNB, gNodeB (gNB), access point (AP), and so on. The term terminal is used interchangeably with the terms user equipment (UE), mobile station (MS), mobile subscriber station (MSS), subscriber station (SS), non-AP station (non-AP STA), and so on.

The wireless communication system may support communication between a base station and a terminal or may support inter-terminal communication. Downlink (DL) in the communication between the base station and the terminal refers to communication from the base station to the terminal. Uplink (UL) refers to communication from the terminal to the base station. For the inter-terminal communication, various communication schemes or services are used, such as device-to-device (D2D), vehicle-to-everything (V2X), a proximity service (ProSe), and sidelink communication. Terminals for the inter-terminal communication include a sensor node, a vehicle, a disaster alarm, and so on.

In addition, a wireless communication system includes a relay and a relay node (RN). In a case where a relay finds application in the communication between the base station and the terminal, the relay serves as a base station communicating with a terminal and also serves as a terminal communicating with a base station. On the other hand, in a case where the relay finds application in the inter-terminal communication, the relay serves as a base station communicating with each of the terminals.

The present disclosure finds application in various multi-access schemes for the wireless communication system. Examples of the multi-access scheme include Code Division Multiple Access (CDMA), Time Division Multiple Access (TDMA), Frequency Division Multiple Access (FDMA), Orthogonal Frequency Division Multiple Access (OFDMA), Single Carrier-FDMA (SC-FDMA), OFDM-FDMA, OFDM-TDMA, OFDM-CDMA, Non-Orthogonal Multiple Access (NOMA), and so on. In addition, a wireless communication system in which the present disclosure finds application may support a Time Division Duplex (TDD) scheme that uses the respective distinctive time resources for uplink communication unit and downlink communication and may support a Frequency Division Duplex (FDD) scheme that uses the respective distinctive frequency resources for uplink communication and downlink communication.

According to the present disclosure, the expression “transmit or receive a channel” has the meaning of “transmit or receive information or a signal over a channel”. For example, the expression “transmit a control channel” has the meaning of “transmit control information or a control signal over a control channel”. Similarly, the expression “transmit data channel” has the meaning of “transmit data information or a data signal over a data channel”.

Hereinafter, examples of the present disclosure for a method for acquiring or designing a linear precoder in a MU-MIMO wireless communication system are described.

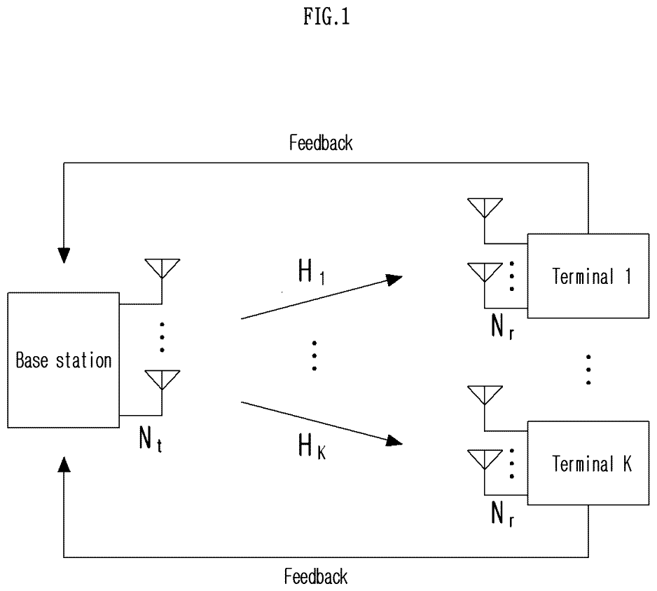

FIG. 1 is a diagram showing a structure of a wireless communication system to which the present disclosure may be applied.

The present disclosure assumes a system in which a base station with Nt antennas uses a downlink to transmit data to K terminals (or users) with Nr antennas, respectively. If a channel between a base station and a k-th user is Hₖ, signal yₖ received by a k-th user may be expressed as follows.

$${y}_{k =} \sqrt{{E}_{s}} {H}_{k} x + {n}_{k} \qquad [ Equation 1 ]$$

In Equation 1, Es represents transmission power, X represents a transmission signal, and nₖ represents a Gaussian noise with an average of 0 experienced at a reception end.

$$x = {\sum }_{k = 1}^{K} {V}_{k} {s}_{k} \qquad [ Equation 2 ]$$

As in Equation 2, transmission signal x is expressed in a form of a product of information (sₖ) to be transmitted to each terminal and a precoder (Vk) applied to transmission to each terminal.

In an actual communication system, channel information must be estimated in each terminal, but the present disclosure is about precoder generation, so it is assumed that perfect channel information may be obtained without an estimation error. In the present disclosure, a purpose of precoder generation is to maximize the sum of transmission rates per frequency for each terminal in data transmission, which may be expressed by the following Equation.

$${max}_{{V}_{1} , . . , {V}_{K}} {\sum }_{k = 1}^{K} {R}_{k} subject to {\sum }_{k = 1}^{K} Tr ( {V}_{k} {V}_{k}^{H} ) \leq {E}_{s} \qquad [ Equation 3 ]$$

In Equation 3, Tr( ) refers to a diagonal sum of a matrix, and X^{H} refers to a Hermitian matrix of a X matrix. In Equation 3, Rₖ refers to a data transmission rate to a k-th terminal, and when the intensity of average noises during data/signal transmission is σₖ², it is expressed as follows.

$${R}_{k} {=}^{Δ} log det ( {I}_{{N}_{r}} + {V}_{k}^{H} {H}_{k}^{H} {H}_{k} {{V}_{k} ( {σ}_{k}^{2} {I}_{{N}_{r}} + {\sum }_{i = 1 , i \neq k}^{K} {H}_{k} {V}_{i} {V}_{i}^{H} {H}_{k}^{H} )}^{- 1} ) \qquad [ Equation 4 ]$$

In Equation 4, det( ) refers to a determinant (determination).

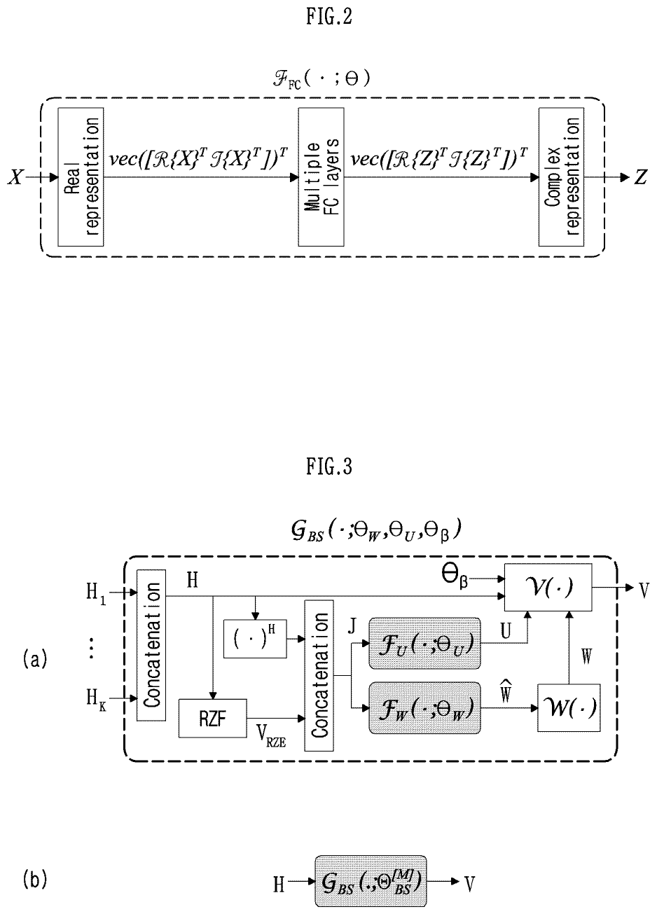

FIG. 2 is a diagram for describing a structure of a fully-connected deep neural network to which the present disclosure may be applied.

A deep neural network (DNN) model, as an example of the machine learning technique, finds application in the present disclosure. However, the scope of the disclosure is not limited to the DNN model, and the principle behind the present disclosure may apply to a similar machine learning technique.

The DNN model is created, on the basis of a human neural network, in the computer science field, and is a model that is made up of various layers that serve as human neurons. A middle layer other than input and output layers is referred to as a hidden layer, and an output of m-th hidden layer is expressed as in Equation 5.

$${x}_{m} = {a}_{m} ( {W}_{m} {x}_{m - 1} + {o}_{m} ) \qquad [ Equation 5 ]$$

where xₘ denotes an output of an m-th layer, oₘ denotes an activation function, Wₘ denotes a weighting factor, and oₘ denotes a bias. That is, the output of the m-th layer is expressed as an output of the activation function of which an input is a value that is obtained by adding a bias of the m-th layer to a result of applying a weighting factor of the m-th layer to an output of an (m−1)-th layer.

A nonlinear relationship between an input and an output, which is difficult to express mathematically, is approximated using the DNN model that includes various layers and various nonlinear activation functions, and a problem that is difficult to solve theoretically can be solved accordingly.

An example in FIG. 2 shows that input complex matrix X obtains output value Z by passing through a fully connected layer neural network configured with a total of L layers and an operation for it may be referred to as [symbol] _{FC}(⋅). In order to use complex matrix X as input in a neural network, transform to a real vector (real representation) is required as in x=vec([ [symbol] {X}^{T}ℑ{X}^{T}])^{T}. When input passes through a neural network, output of a l-th hidden layer may be expressed as in Equation 6.

$$z = {a}_{L} ( {Φ}_{L} ( … ( {Φ}_{2} {a}_{1} ( {Φ}_{1} x + {b}_{1} ) + {b}_{2} ) … ) + {b}_{L} \qquad [ Equation 6 ]$$

Here, Φ₁ refers to a weight of a l-th hidden layer and bₗ represents a bias of a l-th hidden layer. aₗ refers to a non-linear activation function. When output which passed through all layers is referred to as \tilde{z}, an output complex matrix may be calculated as in z=vec([ [symbol] {Z}^{T}ℑ{Z}^{T}])^{T}. Output Z may be obtained through complex representation for output of a fully-connected layer.

When all weights and biases configuring a neural network including a fully connected layer are referred to as θ={Φₗ, bₗ∀l}, the overall mapping relationship between input X, operation [symbol] _{FC}(⋅) and output Z may be expressed as in Equation 7 below.

$$Z = {\text{?}}_{FC} ( X ; θ ) \qquad [ Equation 7 ]$$

FIG. 3 is a diagram for describing a machine learning-based linear precoder design according to an embodiment of the present disclosure.

In a component of FIG. 3(a), [symbol] ^{BS}(⋅) represents an operation that outputs precoder V for channel input H. Precoder V may be obtained based on a precoder calculation formula [symbol] (⋅), and matrix U and W input into a calculation formula [symbol] (⋅) may be extracted based on [symbol] _{U}(⋅; θ_{U}) and [symbol] _{W}(⋅; θ_{W}), respectively. In addition, a parameter used in [symbol] ^{BS}(⋅), a precoder acquisition operation of a base station, may include θ_{W}, θ_{U}, and θ_{β}. A specific description thereof is as follows.

H, a result of concatenating all channel information received from each terminal, (i.g., H=[H₁^{T}, . . . , H_{K}^{T}]^{T}) is an input, and all operations required to obtain a final output which is precoder V for all terminals (i.e., V=[V₁, . . . , V_{K}]) is defined as [symbol] ^{BS}(⋅).

Although it is based on a structure of an WMMSE algorithm, what is intended to be obtained by using a deep neural network in the present disclosure is weight matrix W, reception filter matrix U and normalization constant β of an WMMSE solution formula. Weight matrix W and reception filter matrix U are obtained through a deep neural network consisting of fully connected layers, respectively.

An input used in a deep neural network is J (i.e., J=[H^{H}, V_{RZF}]), where V_{RZF} is a regularized zero forcing (RZF) precoder, which is expressed as follows.

$${V}_{RZF} = {γ}_{RZF} {{H}^{H} ( {HH}^{H} + {β}_{RZF} {I}_{{KN}_{r}} )}^{- 1} \qquad [ Equation 8 ]$$

In Equation 8,

$${γ}_{RZF} = {E}_{s} / Tr ( {V}_{RZF} {V}_{RZF}^{H} )$$

is a constant for a RZF transmission power condition, and

$${β}_{RZF} = {\sum }_{k = 1}^{K} \frac{{σ}_{k}^{2} {N}_{r}}{{E}_{s}}$$

refers to a RZF normalization constant. Weight matrix W and reception filter matrix U of an WMMSE solution may be obtained through two fully connected layer neural networks, respectively. First, an output of a fully connected layer defined as [symbol] _{W}(⋅; θ_{W}) in FIG. 3(a) may be referred to as Ŵ=[Ŵ₁, . . . , Ŵ_{K}], which may be expressed as follows.

$$\hat{W} = ℱ w [ J ; θ w ] \qquad [ Equation 9 ]$$

Since a weight matrix used for an WMMSE solution must have a Hermitian form, an operation required to obtain a weight matrix is defined as follows.

$${W}_{k} = {\hat{W}}_{k} {\hat{W}}_{k}^{H} + {σ}_{k}^{2} {I}_{{N}_{r}} {=}^{Δ} 𝒲 ( {\hat{W}}_{k} ) \qquad [ Equation 10 ]$$

Reception filter matrix U may be obtained as an output of a fully connected layer defined as [symbol] _{U}(⋅; θ_{U}).

$$U = {ℱ}_{U} ( J ; {θ}_{U} ) \qquad [ Equation 11 ]$$

Based on matrixes obtained from two fully connected layer neural networks, precoding matrix V may be obtained as follows.

$$[ Equation 12 ]$$

$$\begin{matrix}V = {γ ( {\sum }_{k = 1}^{K} {H}_{k}^{H} {U}_{k}^{H} {W}_{k} {U}_{k} {H}_{k} + {β}_{DNN} {I}_{{N}_{t}} )}^{- 1} [ {H}_{1}^{H} {U}_{1}^{H} {W}_{1} , … , {H}_{K}^{H} {U}_{K}^{H} {W}_{K} ] \\ {=}^{Δ} 𝒱 ( H )\end{matrix}$$

In Equation 12, γ is a constant for a transmission power condition (γ=Eₛ/Tr(V V^{H})), and

$${β}_{DNN} = {\sum }_{k = 1}^{K} \frac{{σ}_{k}^{2}}{{E}_{s}} Tr ( {W}_{k} {U}_{k} {U}_{k}^{H} ) + {θ}_{β}^{2}$$

represents a normalization constant.

Here, neural network parameter θ_{β} is added as an additional normalization constant in preparation for a channel estimation error and a limited channel feedback situation.

When all deep neural network parameters used in an example of FIG. 3(a) are defined as θ_{BS}≙{θ_{W}, θ_{U}, θ_{β}}, input J of two fully connected layer deep neural networks may be expressed as channel H, so all operations for precoder matrix calculation may be defined as follows.

$$V {=}^{Δ} {𝒢}_{BS} ( H ; {Θ}_{BS} ) \qquad [ Equation 13 ]$$

A deep neural network for obtaining a MU-MIMO linear precoder configured as above may be trained according to the principle of an WMMSE algorithm. In other words, a neural network may be trained to maximize a total transmission rate by using a method (sum-weighted MSE) for minimizing an WMMSE sum according to an updated weight. The training is performed over several steps, and when a loss function is defined as £(⋅), a loss function at a m-th training step may be expressed as follows, as an average value for arbitrary channel variable H.

$$ℒ ( {Θ}_{BS}^{[ m ]} ) {=}^{Δ} {𝔼}_{H} [ {\sum }_{k = 1}^{K} Tr ( {W}_{θ , k}^{[ m - 1 ]} {E}_{k} ( {H}_{k} , {𝒢}_{BS} ( H ; {Θ}_{BS}^{[ m ]} ) ) ) ] \qquad [ Equation 14 ]$$

In Equation 14, Ek is an MMSE matrix, which is expressed as follows.

$${E}_{k} ( {H}_{k} , V ) = {( {I}_{{N}_{r}} + {V}_{k}^{H} {{H}_{k}^{H} ( {σ}_{k}^{2} {I}_{{N}_{r}} + {{\sum }_{i = 1 , i \neq k}}^{K} {H}_{k} {V}_{i} {V}_{i}^{H} {H}_{k}^{H} )}^{- 1} {H}_{k} {V}_{k} )}^{- 1} \qquad [ Equation 15 ]$$

In Equation 14,

$${W}_{θ , k}^{[ m - 1 ]}$$

is a weight matrix, which is calculated as

$${W}_{θ , k}^{[ m - 1 ]} = {{E}_{k} ( {H}_{k} , {𝒢}_{BS} ( H ; {Θ}_{BS}^{[ m - 1 ]} ) )}^{- 1} ,$$

an inverse matrix of a MMSE matrix. Each parameter is updated through a gradient descent method or a stochastic gradient descent (SGD) algorithm.

$${Θ}_{BS}^{[ m ]} ← {Θ}_{BS}^{[ m ]} - {ηΔ}_{{Θ}_{BS}^{[ m ]}} {𝔼}_{H} [ {\sum }_{k = 1}^{K} Tr ( {W}_{θ , k}^{[ m - 1 ]} {E}_{k} ( {H}_{k} , {𝒢}_{BS} ( H ; {Θ}_{BS}^{[ m ]} ) ) ) ] \qquad [ Equation 16 ]$$

If an initial training step is treated as a case for m=0, there is no weight for a previous step in an initial step, so training is performed with the same weight (i.e.,

$${W}_{θ , k}^{[ - 1 ]} = {σ}_{k}^{2} {I}_{{N}_{r}} , {∀}_{k} ) .$$

After a m-th training step converges, all trained parameters are copied to a m+1-th step to ensure that the next fine training is performed at a faster speed. Training is performed while increasing a training step, but a total transmission rate

$${\sum }_{k = 1}^{K} {R}_{k}$$

is calculated at the end of each training step and a training step is increased until this value converges.

If offline training is conducted over a total of M steps (m=0, . . . , M), only a deep neural network trained in a last step is used for actual online communication.

FIG. 3(b) shows a method for obtaining a precoder based on a trained deep neural network. A set of parameters updated/obtained through M-th training may be expressed as θ_{BS}^{[M]}. Through one [symbol] ^{BS}(⋅) operation to which this parameter is applied, precoder V may be obtained from input H. Accordingly, repetitive calculation is unnecessary, so computational complexity is significantly reduced compared to the existing WMMSE algorithm.

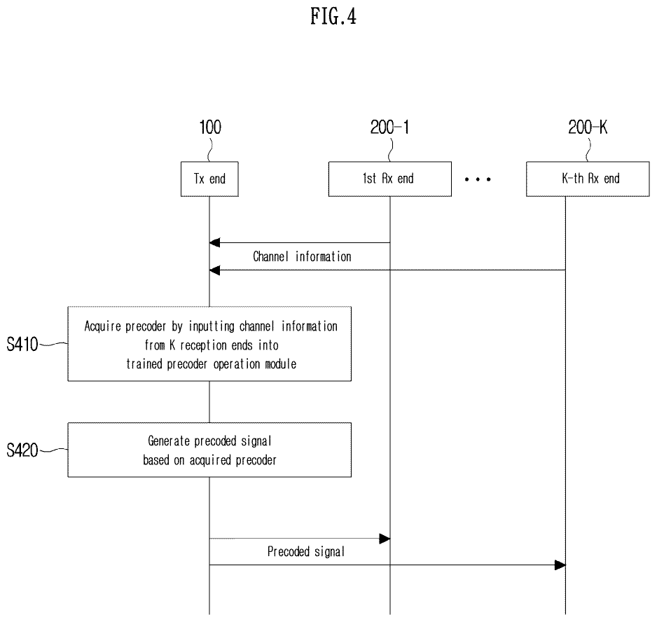

FIG. 4 is a diagram for describing a precoded signal transmission method according to the present disclosure.

In S410, a transmission end (e.g., a base station) may obtain a precoder (V) by inputting channel information (H₁, H₂, . . . , H_{K}) received from each of K reception ends (e.g., a terminal) into a trained precoder operation module.

In S420, a transmission end may transmit a precoded signal to each of K reception ends based on an obtained precoder (V).

Here, a precoder operation module may include a deep neural network to which weight matrix W, reception filter matrix U and normalization constant β are applied. In addition, a precoder operation module may have a structure based on an WMMSE operation structure.

For example, weight matrix W may be obtained through a first fully connected (FC) layer, and reception filter matrix U may be obtained through a second FC layer. If an operation of a precoder operation module or a deep neural network thereof is [symbol] ^{BS}(⋅), precoder V for K reception ends may be obtained through an operation based on parameter θ_{BS} for input H according to the Equation 13.

Here, θ_{BS} may be defined as {θ_{W}, θ_{U}, θ_{β}}, a set of parameters applied to an operation of the deep neural network. Ow may correspond to a set of parameters applied to the first FC layer. θ_{U} may correspond to a set of parameters applied to the second FC layer. θ_{β} may correspond to a set of parameters associated with normalization constant β applied to the deep neural network.

Specific examples of design and training of a precoder operation module or a deep neural network configuring it overlap with the above-described embodiments, so a description is omitted.

According to a linear precoder acquisition method for MU-MIMO according to the present disclosure, although channel state information (CSI) with an error is fed back from a reception end (a terminal) and an incomplete H is input to a precoder operation module, an optimal precoder may be obtained by a deep neutral network operation.

In addition, according to an example of the present disclosure, an optimal precoder may be obtained according to deep neural network parameter β even in a limited feedback situation such as a FDD system. In other words, β may function as a parameter that adjusts an offset of training for incomplete channel feedback.

In particular, since reception filter matrix U is derived through a fully connected layer, an optimal precoder may be obtained based on a MMSE method, but without a repetitive operation. Furthermore, since weight matrix W is derived through a fully connected layer, an optimal precoder may be obtained without a repetitive operation even in an WMMSE method. In other words, since both W and U are derived through a fully connected layer, an optimized linear precoder may be obtained based on an WMMSE algorithm in a MU-MIMO channel situation.

In addition, in a conventional DNN-based precoder design/acquisition method, a total transmission rate was defined as a loss function to derive an optimal solution. In other words, a conventional DNN-based precoder design method has a structure that output V based on input H is derived through one FC layer. In contrast, in the present disclosure, an WMMSE technique and a DNN technique are combined and trained by defining reception filter matrix U and weight matrix W, not a total transmission rate itself, as a loss function. In addition, unlike W and U of the existing WMMSE formula, W and U of the present disclosure are derived through each FC layer, and while W in the existing WMMSE is defined as a weight for calculating a loss function, W in the present disclosure corresponds to an estimated value/an optimal value for a weight matrix through a DNN including a FC layer. Accordingly, when a precoder operation module trained according to the present disclosure is used, it has the advantageous effect of being able to obtain an optimized precoder through one operation.

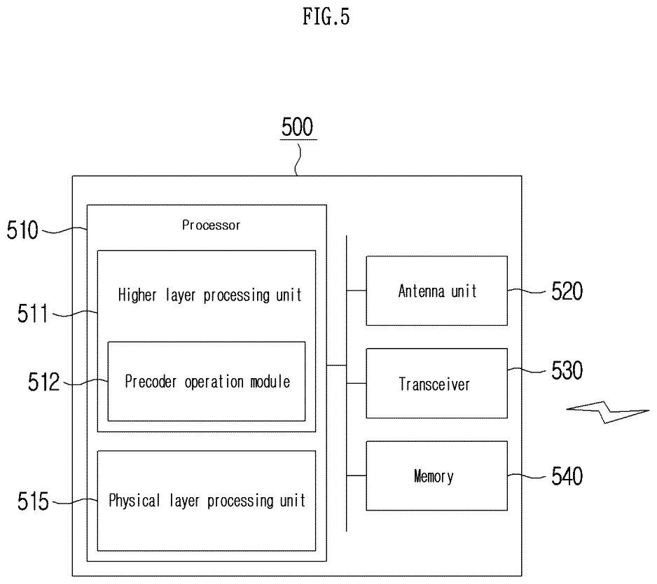

FIG. 5 is a diagram showing a configuration of a transmission device according to the present disclosure.

A transmission device 500 may include a processor 510, an antenna unit 520, a transceiver 530 and a memory 540.

A processor 510 performs baseband-related signal processing, and may include a higher layer processing unit 511 and a physical layer processing unit 515. A higher layer processing unit 511 may process an operation of a MAC layer, a RRC layer or a higher layer or higher. A physical layer processing unit 515 may process an operation of a PHY layer (e.g., transmission/reception signal processing, etc. on an uplink/a downlink/a sidelink). In addition to performing baseband-related signal processing, a processor 510 may also control an overall operation of a transmission device 500.

An antenna unit 520 may include at least one physical antenna, and may support MIMO transmission or reception when it includes a plurality of antennas. A transceiver 530 may include a RF transmitter and a RF receiver. A memory 540 may store information processed by a processor 510, software related to an operation of a transmission device 500, an operating system, an application, etc., and may include a component such as a buffer, etc.

A processor 510 of a transmission device 500 may be configured to implement an operation of a transmission device in embodiments described in the present disclosure.

For example, a higher layer processing unit 511 of a processor 510 of a reception device 500 may include a precoder operation module 512.

A precoder operation module 512 may include a deep neural network to which weight matrix W, reception filter matrix U and normalization constant β are applied. In addition, a precoder operation module 512 may have a structure based on an WMMSE operation structure.

For example, weight matrix W may be obtained through a first fully connected (FC) layer, and reception filter matrix U may be obtained through a second FC layer. If an operation of a precoder operation module 512 or a deep neural network thereof is [symbol] ^{BS}(⋅), precoder V for K reception ends may be obtained through an operation based on parameter Oss for input H according to the Equation 13.

Here, OBs may be defined as {θ_{W}, θ_{U}, θ_{β}}, a set of parameters applied to an operation of the deep neural network. Ow may correspond to a set of parameters applied to the first FC layer. θ_{U} may correspond to a set of parameters applied to the second FC layer. θ_{β} may correspond to a set of parameters associated with normalization constant β applied to the deep neural network.

Specific examples of design and training of a precoder operation module 512 or a deep neural network configuring it overlap with the above-described embodiments, so a description is omitted.

A processor 510 may obtain a precoder (V) by inputting channel information (H₁, H₂, . . . , H_{K}) received from each of K reception ends (e.g., terminals) through a transceiver 530 into a trained precoder operation module 512.

A processor 510 may generate a precoded signal to be transmitted to each of K reception ends based on an obtained precoder (V) through a physical layer processing unit 515 and transmit it through a transceiver 530 and an antenna 520.

A description of a transmission end in examples of the present disclosure may be equally applied to an operation of a transmission device 500, and an overlapping description is omitted.

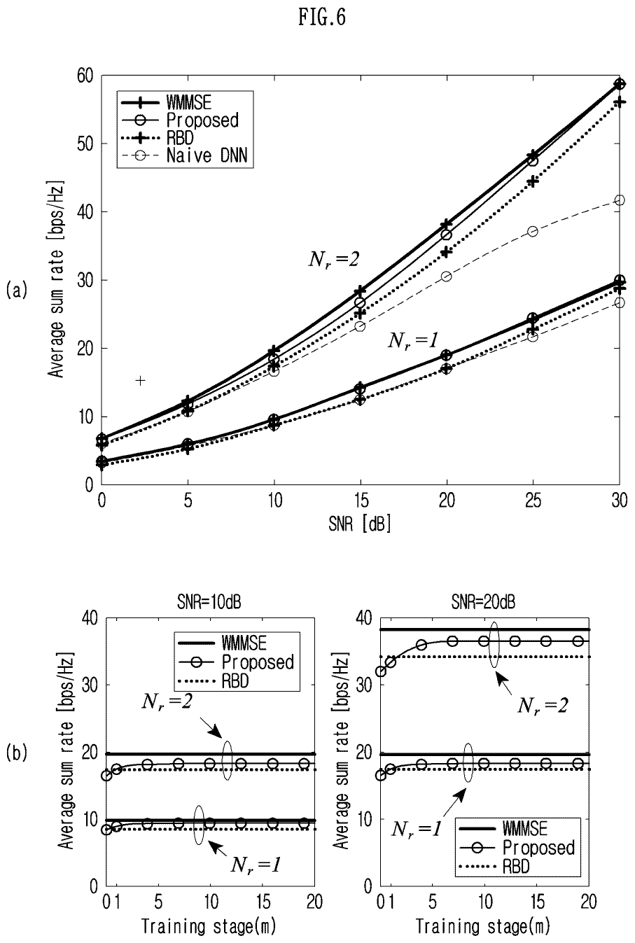

FIG. 6 is a diagram showing a simulation result according to examples of the present disclosure.

In an example of FIG. 6, a channel model used for training a deep neural network trained a system in which a channel model with a rayleigh block fading property was used, a single base station and four users/terminals (i.e., K=4) were assumed, the number of antennas of a base station was configured as Nₜ=KNᵣ and the number of antennas for each user was configured as Nr.

A result according to an example of the present disclosure was compared with an WMMSE algorithm technique and a regularized block diagonalization (RBD) technique.

FIG. 6(a) shows a total transmission rate according to the number of antennas of each user. In an example (Proposed) according to the present disclosure, although a repetitive operation was not performed, it shows that performance is close to that of an WMMSE algorithm and shows more excellent performance than that of a RBD technique. In addition, it is observed that the performance of an example of the present disclosure is far superior to that of a deep neural network (Naive DNN) consisting of only fully connected layers.

FIG. 6(b) shows a change in performance according to a training step of an artificial deep neural network. As a training step progresses, it may be confirmed that the performance of a total transmission rate improves, and it may be confirmed that a result (Proposed) according to examples of the present disclosure behaves similarly to the existing WMMSE algorithm.

Table 1 shows computational complexity measured online after pre-training is completed for a case of Nᵣ=1, and Table 2 shows computational complexity measured online after pre-training is completed for a case of Nᵣ=2. A result (Proposed) according to examples of the present disclosure shows performance similar to that of an WMMSE algorithm, but computational complexity is significantly reduced compared to an WMMSE algorithm due to the omission of a repetitive operation.

TABLE 1

| | WMMSE | | | |
|---|---|---|---|---|
| Proposed | SNR = 0 dB | SNR = 10 dB | SNR = 20 dB | SNR = 30 dB |
| 0.279 | 5.9962 | 6.9168 | 15.501 | 15.676 |

TABLE 2

| | WMMSE | | | |
|---|---|---|---|---|
| Proposed | SNR = 0 dB | SNR = 10 dB | SNR = 20 dB | SNR = 30 dB |
| 0.589 | 12.265 | 17.179 | 56.112 | 91.436 |

Exemplary methods according to the present disclosure are described as a sequence of operations for clear description, but this is not intended to impose any limitation on the order in which steps are performed. If necessary, the steps may be performed simultaneously or in a different order. In order to implement the method according to the present disclosure, one or several other steps may be included in addition to the steps described above. Alternatively, one or several of the steps described above may be omitted. Alternatively, one or several of the steps described above may be omitted, and one or several other steps may be included.

The various embodiments of the present disclosure, which are described above, do not include all possible combinations of the constituent elements and are provided only for descriptions of representative aspects of the present disclosure. The constituent elements described according to the various embodiments may be applied independently or in combination.

In addition, the various embodiments of the present disclosure can be implemented in firmware, in software, or with a combination of these. The various embodiment can be implemented by at least one of the following: Application Specific Integrated Circuits (ASICs), Digital Signal Processors (DSPs), Digital Signal Processing Devices (DSPDs), Programmable Logic Devices (PLDs), Field Programmable Gate Arrays (FPGAs), general processors, controllers, micro controllers, microprocessors, and the like.

The scope of the present disclosure includes software or machine-executable commands (for example, an operating system, an application, firmware, a program, and the like) that cause a device or a computer to perform the methods according to the various embodiments, and a non-transitory computer-readable medium on which the software or the commands are recorded in a manner that is executable on the device or the computer.

### INDUSTRIAL AVAILABILITY

Examples of the present disclosure may be applied to a precoding method in a variety of wireless communication systems.

1. A method for transmitting a signal based on a precoder by a transmission end in a multi-user multiple input multiple output (MIMO) wireless communication system, the method comprising:
acquiring the precoder by inputting channel information received from each of K (K is an integer greater than 0) reception end into a trained precoder operation module; and
transmitting a precoded signal to the each of the K reception end based on the acquired precoder,
wherein the precoder operation module includes a deep neural network to which a weight matrix W, a reception filter matrix U, and a normalization constant β are applied.

2. The method of claim 1, wherein:
the precoder operation module is based on a weighted minimum squared error (WMMSE) operation structure.

3. The method of claim 2, wherein:
the weight matrix W is acquired through a first fully connected (FC) layer,
the reception filter matrix U is acquired through a second FC layer.

4. The method of claim 3, wherein:
the precoder operation module is expressed as an equation V≙ [symbol] ^{BS}(H; θ_{BS}),
V corresponds to the precoder,
H corresponds to a set of the channel information received from the each of the K reception end, [symbol]
^{BS}(⋅) corresponds to an operation of the deep neural network,
θ_{BS} is expressed as Θ_{BS}≙{θ_{W}, θ_{U}, θ_{β}} as a set of a parameter applied to the operation of the deep neural network,
θ_{W} corresponds to a set of a parameter applied to the first FC layer,
θ_{U} corresponds to a set of a parameter applied to the second FC layer,
θ_{β} corresponds to a set of a parameter associated with a normalization constant β applied to the deep neural network.

5. The method of claim 4, wherein:
the weight matrix W and the reception filter matrix U are input into a precoder calculation formula [symbol] (⋅), and the normalization constant β is applied to [symbol] (⋅).

6. The method of claim 5, wherein:
the transmission end includes Nt transmission antenna, and the each of the K reception end includes Nr reception antenna.

7. The method of claim 6, wherein:
an input J for the first FC layer and the second FC layer corresponds to [H^{H}, V_{RZF}]),
H corresponds to [H₁^{T}, . . . , H_{K}^{T}]^{T} with which H₁, . . . , H_{K}, the channel information received from the each of the K reception end, is associated,
V_{RZF} is expressed as an equation V_{RZF}=γ_{RZF}H^{H}(HH^{H}+β_{RZF}I_{KN}_{ᵣ})⁻¹,
γ_{RZF} corresponds to a constant for a regularized zero forcing (RZF) transmission power condition,
β_{RZF} corresponds to a RZF normalization constant.

8. The method of claim 7, wherein:
it is defined as
$${γ}_{RZF} = {E}_{s} / Tr ( {V}_{RZF} {V}_{RZF}^{H} ) and {β}_{RZF} = {\sum }_{k = 1}^{K} \frac{{σ}_{k}^{2} {N}_{r}}{{E}_{s}} ,$$
Es corresponds to a transmission power of the transmission end,
σₖ² corresponds to an average noise intensity for a k-th reception end among K reception end.

9. The method of claim 8, wherein:
a weight matrix Wₖ for a k-th reception end among the weight matrix W input into the precoder calculation formula [symbol] (⋅) is defined as an equation
$${W}_{k} = {\hat{W}}_{k} {\hat{W}}_{k}^{H} + {σ}_{k}^{2} {I}_{{N}_{r}} {=}^{Δ} 𝒲 ( {\hat{W}}_{k} ) ,$$
$$\hat{W} = ℱ w [ J ; θ w ] , \\ \hat{W} = [ {\hat{W}}_{1} , … , {\hat{W}}_{k} ] ,$$ [symbol]
_{W}(⋅; θ_{W}) is the first FC layer.

10. The method of claim 9, wherein:
the reception filter matrix U input into the precoder calculation formula [symbol] (⋅) is U= [symbol] _{U}(J; θ_{U}), [symbol]
_{U}(⋅; θ_{U}) is the second FC layer.

11. The method of claim 10, wherein:
the precoder V is acquired through
$$\begin{matrix}V = {γ ( {\sum }_{k = 1}^{K} {H}_{k}^{H} {U}_{k}^{H} {W}_{k} {U}_{k} {H}_{k} + {β}_{DNN} {I}_{{N}_{t}} )}^{- 1} [ {H}_{1}^{H} {U}_{1}^{H} {W}_{1} , … , {H}_{K}^{H} {U}_{K}^{H} {W}_{K} ] \\ {=}^{Δ} 𝒱 ( H ) ,\end{matrix}$$
γ corresponds to a constant for a transmission power condition,
β_{DNN} corresponds to the normalization constant β.

12. The method of claim 11, wherein:
$$γ = {E}_{s} / Tr ( V {V}^{H} ) , \\ {β}_{DNN} = {\sum }_{k = 1}^{K} \frac{{σ}_{k}^{2}}{{E}_{s}} Tr ( {W}_{k} {U}_{k} {U}_{k}^{H} ) + {θ}_{β}^{2} .$$

13. The method of claim 4, wherein:
θ_{BS} is updated to minimize a sum of an WMMSE by a m(=0, 1, . . . , M)-th training for the precoder operation module, and M training is performed until a total transmission rate converges to a maximum value.

14. The method of claim 13, wherein:
the trained precoder operation module corresponds to a deep neural network to which θ_{BS}^{[M]}, a parameter set updated by a M-th training, is applied,
an output V is acquired through a single operation by applying an input H to the trained precoder operation module.

15. A transmission device for transmitting a signal based on a precoder in a multi-user multiple input multiple output (MIMO) wireless communication system, the transmission device comprising:
a transceiver;
an antenna unit;
a memory; and
a processor,
wherein the processor is configured to:
acquire the precoder by inputting channel information received from each of K (K is an integer greater than 0) reception end into a trained precoder operation module; and
transmit, through the transceiver, a precoded signal to the each of the K reception end based on the acquired precoder,
wherein the precoder operation module includes a deep neural network to which a weight matrix W, a reception filter matrix U, and a normalization constant β are applied.
